(19) United States
(12) Patent Application Publication
(10) Pub. No.: US 2005/0273355 A1
(43) Pub. Date: Dec. 8, 2005

(54) Printing system, service data provision method and service data provision program

(75) Inventor: Shinya Yamada, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/144,749

(22) Filed: Jun. 6, 2005

(30) Foreign Application Priority Data
Jun. 4, 2004 (JP) 2004-167375

(51) Int. Cl. G06F 17/60

(52) U.S. Cl. 705/1

(57) ABSTRACT

A printing system comprising: an instruction input device for a user to input an operation instruction; a printing device which performs printing in response to a printing instruction by the user; a service data output device which outputs predetermined service data during execution of printing; a service data storage device in which multiple service data are stored; and a control device which searches the service data storage device to select service data to be outputted based on the number of prints or the fee of prints specified by the printing instruction.

### BACKGROUND OF THE INVENTION

1. Field of the Invention

The present invention relates to a printing system, and in particular to a printing system which provides a service by utilizing the waiting time during printing.

2. Related Art

There have been proposed techniques for an apparatus having a printing function, for preventing a user from being bored during the waiting time from when the user issues a printing instruction until when the printing ends. For example, Japanese Patent Application Laid Open No. 05-330204 discloses a word processor apparatus which plays a melody in synchronization with printing.

Japanese Patent Application Laid Open No. 10-304285 discloses a printing apparatus which is provided with a video camera, a video printer and a data storage section with decorative design data and time-killing service data stored therein and which provides the time-killing service data when an image taken by a video camera is synthesized with the decorative design data and printed.

Japanese Patent Application Laid Open No. 2002-157101 discloses an advertisement information provision system (network printer) which sends advertisement information data to a client terminal during the waiting time while printing is performed in response to an instruction from the client terminal.

### SUMMARY OF THE INVENTION

Recently, there has been commonly used a so-called POS self-service printer installed at a mass retailer of white goods and the like, which is used by a user to perform self-service printing of photo images he took with a digital camera or the like and brought to the mass retailer of white goods. When using such a POS self-service printer, the user is often bored during the print waiting time. The print waiting time is longer in proportion to the number of prints, and some users avoid printing a lot of images for this reason.

The above techniques disclosed in Japanese Patent Application Laid Open No. 05-330204, Japanese Patent Application Laid Open No. 10-304285 and Japanese Patent Application Laid Open No. 2002-157101 are intended to prevent a user from being bored during the print waiting time by giving a melody, time-killing service data or advertisement information. However, such melody, time-killing service data and advertisement information have not sufficiently played a role of pastime during the waiting time because similar content is provided every time in many cases. As a result, there is a problem that repeater visitors cannot be secured and the operation rate of the apparatus is low.

The present invention has been made in consideration of the above situation, and its object is to provide a printing system capable of effectively utilizing the print waiting time by providing various services, a service data provision method and a service data provision program.

To achieve the above object, a printing system according to a first aspect of the present invention comprises: an instruction input device for a user to input an operation instruction; a printing device which performs printing in response to a printing instruction by the user; a service data output device which outputs predetermined service data during execution of printing; a service data storage device in which multiple service data are stored; and a control device which searches the service data storage device to select service data to be outputted based on the number of prints or the fee of prints specified by the printing instruction.

According to the printing system of the first aspect, it is possible to effectively utilize the printing time by providing various services for a user during the print waiting time.

A printing system according to a second aspect of the present invention comprises: an instruction input device for a user to input an operation instruction; a printing device which performs printing in response to a printing instruction by the user; a service data output device which outputs predetermined service data during execution of printing; a service data storage device in which multiple service data are stored; and a control device which selects service data to be outputted; wherein the control device searches the service data storage device to present a predetermined service data group to the user based on the number of prints or the fee of prints, and accepts input of a service data selection instruction from the instruction input device.

According to the printing system of the second aspect, it is possible for a user to select a desired service, in addition to the effect described above.

As shown in a third aspect of the present invention, in the printing system according to the first or second aspect, the service data output device comprises a picture display device which displays a picture and a voice output device which outputs a voice; and the service data includes at least one of picture data and voice data.

As shown in a fourth aspect of the present invention, in the printing system according to any one of the first to third aspects further comprises a communication device which communicates with an external network; wherein the control device is capable of capturing the latest service data from an external network into the service data storage device.

According to the printing system of the fourth aspect, it is possible to easily update service data. Furthermore, it is possible to continue providing a variety of information such as news and weather forecast.

A service data provision method according to a fifth aspect of the present invention is a method of providing service data for a user in a printing system which prints an image of the user, the method comprising the steps of: performing printing in response to a printing instruction by the user; searching a service data storage device in which multiple service data are stored to select service data to be outputted based on the number of prints or the fee of prints specified by the printing instruction; and outputting the selected service data with the use of a service data output device during execution of printing.

A service data provision method according to a sixth aspect of the present invention is a method of providing service data for a user in a printing system which prints an image of the user, the method comprising the steps of: performing printing in response to a printing instruction by the user; searching a service data storage device in which multiple service data are stored to present a predetermined service data group to the user based on the number of prints or the fee of prints specified by the printing instruction; accepting input of a service data selection instruction from the user; and outputting the selected service data with the use of a service data output device during execution of printing.

A service data provision program according to a seventh aspect of the present invention is a program for providing service data for a user in a printing system which prints an image of the user; the program causing a computer to realize the functions of: performing printing in response to a printing instruction by the user; searching a service data storage device in which multiple service data are stored to select service data to be outputted based on the number of prints or the fee of prints specified by the printing instruction; and outputting the selected service data with the use of a service data output device during execution of printing.

A service data provision program according to an eighth aspect of the present invention is a program for providing service data for a user in a printing system which prints an image of the user, the program causing a computer to realize the functions of: performing printing in response to a printing instruction by the user; searching a service data storage device in which multiple service data are stored to select a predetermined service data group based on the number of prints or the fee of prints specified by the printing instruction; and presenting the selected service data group to the user; accepting input of a service data selection instruction from the user; and outputting the selected service data with the use of a service data output device during execution of printing.

According to the present invention, it is possible to effectively utilize the print waiting time by providing various services for a user, and the user is prevented from being bored. Accordingly, the number of users who print a lot of images increases, and increase of the operation rate of a printing system can be expected.

### BRIEF DESCRIPTION OF THE DRAWINGS

FIG. 1 is a block diagram showing a printing system according to an embodiment of the present invention;

FIG. 2 is a flowchart showing a printing method; and

FIG. 3 shows a service data management table.

### DETAILED DESCRIPTION OF THE PREFERRED EMBODIMENTS

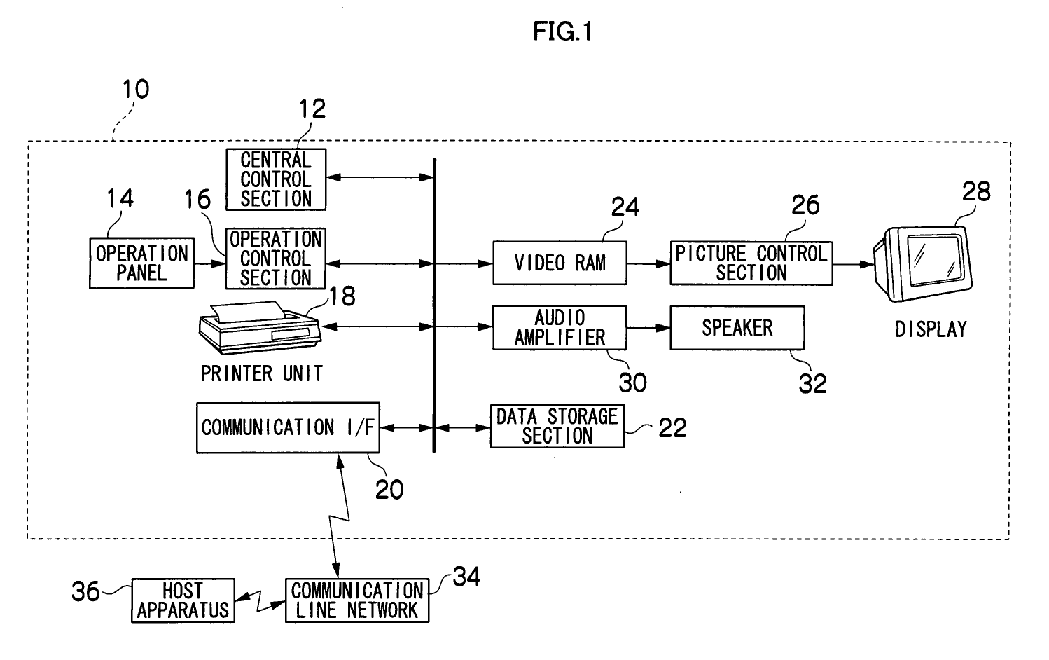

A preferred embodiment of a printing system according to the present invention will be described below with reference to accompanying drawings. FIG. 1 is a block diagram showing a printing system according to an embodiment of the present invention.

As shown in FIG. 1, a printing system 10 is provided with a central control section (CPU) 12, an operation panel 14, an operation control section 16, a printer unit 18, a communication I/F 20, a data storage section 22, a video RAM 24, a picture control section 26, a display 28 and an audio amplifier 30 and a speaker 32.

The CPU 12 is a control section which performs overall control of the printing system 10. The CPU 12 controls the operation of the printing system 10 based on input from the operation panel 14 and the like.

The operation panel 14 is provided with operation buttons for a user to perform an operation input, a display unit for displaying the content of the operation input or response information, an image input device such as a media reader, and a slot for paying a fee, and is connected to the CPU 12 via the operation control section 16.

The communication I/F 20 is a device for connecting to a communication line network 34 and performs sending/receiving of various data in accordance with a predetermined protocol. The printing system 10 is connected to a host apparatus 36 via the communication I/F 20 and the communication line network 34.

The data storage section 22 includes a hard disk device in which a service data management table (to be described later) for managing waiting-time-frustration relieving service data (referred to as service data in the description below) to be given during the printing operation of a printer and service data, programs to be processed by the CPU 12 and various data required for control are stored; and a SDRAM to be a storage area where image data inputted by a user is stored and a work area where the CPU 12 performs various arithmetic processings and the like.

During the printing operation, service data is read by the CPU 12 from the data storage section 22 in accordance with predetermined selection criteria. Picture data among the read service data is developed in the video RAM 24 and displayed on the display 28 via the picture control section 26. Meanwhile, voice data is outputted from the speaker 32 via the audio amplifier 30. If the service data includes both picture data and voice data, the CPU 12 gives an instruction to synchronize the picture and the voice.

Here, the service data is data such as advertisement information and a program of a game, a quiz and a jukebox function. It is also possible to acquire service data such as news, weather forecast and traffic information from the communication line network 34 and the host apparatus 36 described above and to update existing service data.

Though the printing system 10 of this embodiment is connected to the communication line network 34, the present invention is not limited thereto, and a stand-alone type system without the communication I/F 20 may be possible.

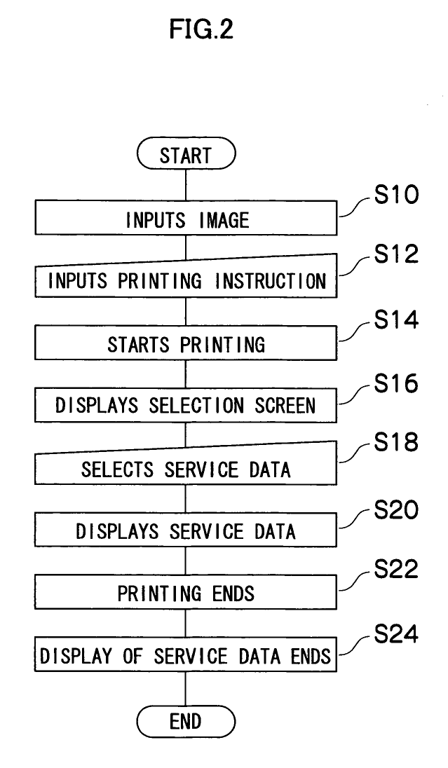

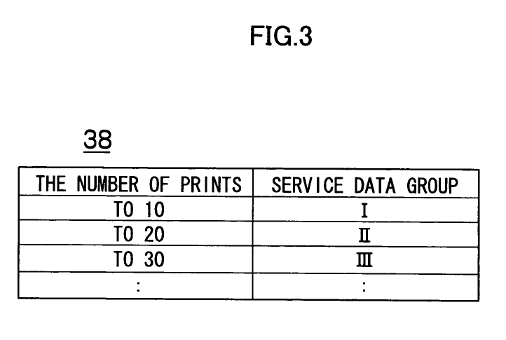

A method of performing printing with the use of the printing system 10 of this embodiment will be now described with reference to FIGS. 2 and 3. FIG. 2 is a flowchart showing the printing method.

First, an image is inputted to the printing system 10 from a digital camera or a recording medium brought by a user (step S10). The images, the number of images, the image quality and the like are specified by operating the operation panel 14 and a printing instruction is inputted (step S12).

When printing is started (step S14), a service data management table is retrieved by the CPU 12 in accordance with predetermined criteria, and a service data selection screen is displayed on the display 28 (step S16).

The service data selection criterion will be now described. As described above, the printing system 10 of this embodiment has a service data management table in the data storage section 22. FIG. 3 shows a service data management table.

In a service data management table 38 shown in FIG. 3, the number of prints and a service data group is stored in association with each other. At step S16, a group of service data selectable by a user is determined by the CPU 12 based on the number of prints specified by the printing instruction and displayed on the service data selection screen.

Returning to description of the flowchart in FIG. 2, the process then proceeds to step S18, where the user operates the operation panel 14 to select desired service data from the service data selection screen. Then, the selected service data is given by the display 28, the speaker 32 or the like (step S20). When printing ends (step S22), display of the service data is also terminated (step S24).

Though it is assumed that a service data group is determined from the number of prints in this embodiment, it may be determined, for example, from the fee of prints or the time required for printing which is estimated from specification of the number of prints, the image quality and the like performed when printing is instructed.

Though it is assumed that a user can select desired service data from a group of service data in this embodiment, service data to be displayed may be automatically determined based on the number of prints.

A configuration is also possible for this embodiment, in which use history of a user is recorded and service data (a service data group) is selected based on this use history. Thus, it is possible to provide a detailed service for each user.

1. A printing system comprising:
an instruction input device for a user to input an operation instruction;
a printing device which performs printing in response to a printing instruction by the user;
a service data output device which outputs predetermined service data during execution of printing;
a service data storage device in which multiple service data are stored; and
a control device which searches the service data storage device to select service data to be outputted based on the number of prints or the fee of prints specified by the printing instruction.

2. A printing system comprising:
an instruction input device for a user to input an operation instruction;
a printing device which performs printing in response to a printing instruction by the user;
a service data output device which outputs predetermined service data during execution of printing;
a service data storage device in which multiple service data are stored; and
a control device which selects service data to be outputted; wherein
the control device searches the service data storage device to present a predetermined service data group to the user based on the number of prints or the fee of prints, and accepts input of a service data selection instruction from the instruction input device.

3. The printing system according to claim 1, wherein
the service data output device comprises a picture display device which displays a picture and a voice output device which outputs a voice; and
the service data includes at least one of picture data and voice data.

4. The printing system according to claim 2, wherein
the service data output device comprises a picture display device which displays a picture and a voice output device which outputs a voice; and
the service data includes at least one of picture data and voice data.

5. The printing system according to claim 1, further comprising: a communication device which communicates with an external network; wherein
the control device is capable of capturing the latest service data from an external network into the service data storage device.

6. The printing system according to claim 2, further comprising: a communication device which communicates with an external network; wherein
the control device is capable of capturing the latest service data from an external network into the service data storage device.

7. The printing system according to claim 3, further comprising: a communication device which communicates with an external network; wherein
the control device is capable of capturing the latest service data from an external network into the service data storage device.

8. The printing system according to claim 4, further comprising: a communication device which communicates with an external network; wherein
the control device is capable of capturing the latest service data from an external network into the service data storage device.

9. A method of providing service data for a user in a printing system which prints an image of the user, the method comprising the steps of:
performing printing in response to a printing instruction by the user;
searching a service data storage device in which multiple service data are stored to select service data to be outputted based on the number of prints or the fee of prints specified by the printing instruction; and
outputting the selected service data with the use of a service data output device during execution of printing.

10. A method of providing service data for a user in a printing system which prints an image of the user, the method comprising the steps of:
performing printing in response to a printing instruction by the user;
searching a service data storage device in which multiple service data are stored to present a predetermined service data group to the user based on the number of prints or the fee of prints specified by the printing instruction;
accepting input of a service data selection instruction from the user; and
outputting the selected service data with the use of a service data output device during execution of printing.

11. A program for providing service data for a user in a printing system which prints an image of the user, the program causing a computer to realize the functions of:
performing printing in response to a printing instruction by the user;
searching a service data storage device in which multiple service data are stored to select service data to be outputted based on the number of prints or the fee of prints specified by the printing instruction; and
outputting the selected service data with the use of a service data output device during execution of printing.

12. A program for providing service data for a user in a printing system which prints an image of the user, the program causing a computer to realize the functions of:
performing printing in response to a printing instruction by the user;
searching a service data storage device in which multiple service data are stored to select a predetermined service data group based on the number of prints or the fee of prints specified by the printing instruction; and
presenting the selected service data group to the user;
accepting input of a service data selection instruction from the user; and
outputting the selected service data with the use of a service data output device during execution of printing.
